(19) United States
(12) Patent Application Publication
(10) Pub. No.: US 2018/0144384 A1
(43) Pub. Date: May 24, 2018

(54) Methods And Systems Relating To Purchasing Decision Making

(71) Applicant: Benoit LALONDE, Orleans (CA)

(72) Inventor: Benoit LALONDE, Orleans (CA)

(21) Appl. No.: 15/568,305

(22) PCT Filed: Apr. 12, 2016
(86) PCT No.: PCT/CA2016/000110

§ 371 Date: Oct. 20, 2017

Related U.S. Application Data
(60) Provisional application No. 62/154,780, filed on Apr. 30, 2015.

(51) Int. Cl. G06Q 30/06; G06Q 10/08

(52) U.S. Cl. CPC G06Q 30/0623; G06Q 10/0875

(57) ABSTRACT

This invention relates to a method and system for obtaining repair estimates, and/or checking fairness of an estimate with only limited knowledge. Further, this invention allows the user to adjust an estimate by selecting varying elements, such as manufacturer, replacing original equipment manufacturer parts with secondary market manufacturer parts, or adjusting the specification of a part or parts.

### FIELD OF THE INVENTION

This invention relates to purchasing and more particularly to providing purchasers with contextually relevant information for informed decision making with respect to options available.

### BACKGROUND OF THE INVENTION

When equipment must be repaired, the repair may, or may not, be covered by a warranty on the equipment. Thus, it is typically first determined whether the equipment is still under warranty and, if so, what components are covered thereby. For example, it is now common for manufacturers to apply warranties of different length to different components or systems of an item of equipment. If a repair is fully covered by a warranty, the cost of the repair is generally of no concern to the equipment owner, lessee, or other party responsible for or interested in the equipment (all of which are hereinafter considered to be a “equipment owner” for purposes of the present invention), because the repair will be paid for by the equipment manufacturer or an insurance carrier. However, if the entire warranty on equipment in need of repair has expired, or if the particular component(s) in need of repair or replacement is no longer covered by the warranty, the cost of the repair is of much greater interest to the equipment owner—as, in this situation, it is the equipment owner that will likely pay for the repair.

The problem with the latter of the above-described situations is that a typical equipment owner has little or no idea what a particular equipment repair should cost nor of the tradeoffs inherent in repairing it. Even with simple repairs, there may be component purchase costs, component disposal costs, removal and installation charges, and several other possible expenses that may be incurred by the equipment owner. With more complex repairs, which are not necessarily unusual with respect to today's more complex equipment, the explanation of repairs and their associated costs may perplex even knowledgeable equipment enthusiasts.

In this situation, the equipment owner is left substantially at the mercy of the equipment dealer or other repair facility to which the ailing equipment has been taken. The equipment owner must trust that the repair facility will quote an honest and fair cost for the work to be done. Unfortunately, while the vast majority of equipment repair facilities are likely honest and do quality work, there are inevitably those that do not. In addition, even substantially honest repair facilities often make money by adding a service, delivery, or some other aptly-named charge to the cost of replacement components, and/or by taking more than a manufacturer-determined amount of time to complete a repair.

In addition to forced reliance on the honesty of an equipment repair facility, an owner of the equipment in need of repair may be in the somewhat unique position of not being able to obtain more than one repair estimate, or to otherwise shop around for a better deal. While in some situations this may not be the case, there are many repair scenarios wherein the equipment to be repaired cannot, or should not, be driven to another repair facility. Certainly, there are those situations where the equipment in need of repair cannot even be driven to a repair facility under its own power. In such situations, the equipment owner is not in a position to obtain multiple estimates which can then be compared. Rather, the equipment owner will likely be forced to pay the repair amount quoted by a single repair facility, or face the danger or towing expenses involved in transporting the equipment to another repair facility. And, even if an additional estimate(s) is sought out, there is no guarantee that another repair facility will be able to complete the repair in question any less expensively.

Unfortunately, another downside to obtaining only one estimate (aside from forced reliance on the integrity of the repair facility in question) is that many repair shops, even in those in general proximity to one another, often charge different amounts for the same repair. This can be attributed to several factors. For example, dealer repair facilities often charge more for a given repair than a locally owned or small chain-type repair facility. And, even dealers within a similar geographic area may quote different amounts for the same repair. Some dealers simply charge more than others; whether it be because they are more upscale, offer more services to their customers, or generally have just earned a reputation for performing good work. Dealers may also add varying delivery or other charges to the cost of replacement components. These same discrepancies often hold true for non-dealer repair facilities as well. Consequently, in many circumstances, it may be beneficial for an equipment owner to obtain more than one repair estimate—even if from repair facilities in close proximity to one another.

Since, as stated above, this is often not possible, or practical for that matter, the alternative would be for the equipment owner to have access to repair information that could be used to determine a fair cost for a given equipment repair. Unfortunately, very few equipment owners have access to such information and, even if they did, might not be able to adequately use the information to determine a fair repair cost. There are no books, databases or other sources of such information to which the average equipment owner has access. Additionally, determining the overall cost of a repair, even with access to such information is not necessarily an easy task. While the advent of computers and databases has made the process of providing a repair estimate look fairly undaunting, the fact is that the process can be quite complex—especially for equipment owners with little understanding of their equipment, or of equipment in general. Thus, even armed with a detailed estimate and with access to a database(s), an average equipment owner may find it difficult, if not impossible, to determine a fair repair cost.

Consequently, what is needed by the average equipment owner is a system and method by which an equipment owner can obtain a repair estimate, and/or check the fairness of a repair estimate, with only limited knowledge regarding the equipment to be repaired. The system and method of the present invention provides a means by which an average equipment owner can obtain and/or check the fairness of a repair estimate, even if the equipment owner has little or virtually no knowledge regarding the specifics of the equipment to be repaired. The system and method of the present invention also provides a means by which a knowledgeable equipment owner can generate a repair estimate by entering more detailed information about the equipment and the needed repair. An initial repair estimate can be generated, or an existing repair estimate can be checked, quickly and from virtually any location.

It would be further beneficial for the equipment owner to be provided with the ability to adjust an estimate by selecting/varying elements within the estimate such as changing a manufacturer, replacing original equipment manufacturer parts with secondary market manufacturer parts, or adjusting the specification of the part or parts. However, in doing so the user should be prevented or limited from decisions that are not advisable, such as fitting tires with a very low weight rating to a truck for business use, or allowing them to balance their desired performance versus expenditure.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations within the prior art relating to purchasing and more particularly to providing purchasers with contextually relevant information for informed decision making with respect to options available.

In accordance with an embodiment of the invention there is provided a method of providing contextually aware variations to a work order by receiving an input from a user relating to a variation in an item within the work order and displaying to the user adjustments in other aspects of the work order in dependence of the variation made to an item.

In accordance with an embodiment of the invention there are provided computer instructions stored within a non-volatile, non-transitory memory for execution by a microprocessor, wherein the computer instructions cause a process to be executed comprising providing contextually aware variations to a work order by receiving an input from a user relating to a variation in an item within the work order and displaying to the user adjustments in other aspects of the work order in dependence of the variation made to an item.

In accordance with an embodiment of the invention there is provided a method comprising:
receiving at a remote server first data from a user generated upon an electronic device, the first data relating to a context;
receiving at the remote server second data from a user generated upon the electronic device, the second data relating to a work order;
receiving at the remote server third data from a user generated upon the electronic device, the third data relating to a variation in an item of the work order;
generating options based upon the third data, the second data, and the first data; and transmitting the options from the remote server to the electronic device for display to the user.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1A depicts an example of a network environment within which embodiments of the invention are employed and exploited;

FIG. 1B depicts an example of a typical portable electronic device supporting employment and exploitation of embodiments of the invention as communicating with the network environment presented in FIG. 1A;

FIG. 2 depicts an exemplary flow chart for a software application supporting PURDE-FRASAPs according to an embodiment of the invention;

FIG. 3 depicts steps within a client driven search and decision process within a software application supporting PURDE-FRASAPs according to an embodiment of the invention;

FIG. 4 depicts steps within a technician inspection search and decision process within a software application supporting PURDE-FRASAPs according to an embodiment of the invention;

FIG. 5 depicts steps within a client driven search and decision process within a software application supporting PURDE-FRASAPs according to an embodiment of the invention;

FIG. 6 depicts steps within a client driven post-purchasing decision process within a software application supporting PURDE-FRASAPs according to an embodiment of the invention;

FIG. 7 depicts a context determination process for a PURDE-FRASAP according to an embodiment of the invention;

FIG. 8 depicts contextually driven decision making process within a PURDE-FRASAP according to an embodiment of the invention;

FIG. 9 depicts a contextually driven decision making process within a PURDE-FRASAP according to an embodiment of the invention;

FIG. 10 depicts a contextually driven balanced purchasing decision variation methodology within a PURDE-FRASAP according to an embodiment of the invention;

FIGS. 11A and 11B depict a balanced purchasing decision variation methodology within a PURDE-FRASAP according to an embodiment of the invention; and

FIG. 12 depicts schematically knowledge base creation through aggregation of data obtained/derived through PURDE-FRASAPs according to an embodiment of the invention.

### DETAILED DESCRIPTION

The present invention is directed to purchasing and more particularly to providing purchasers with contextually relevant information for informed decision making with respect to options available.

The ensuing description provides exemplary embodiment(s) only, and is not intended to limit the scope, applicability or configuration of the disclosure. Rather, the ensuing description of the exemplary embodiment(s) will provide those skilled in the art with an enabling description for implementing an exemplary embodiment. It being understood that various changes may be made in the function and arrangement of elements without departing from the spirit and scope as set forth in the appended claims.

A “portable electronic device” (PED) as used herein and throughout this disclosure, refers to a wireless device used for communications and other applications that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, and an electronic reader.

A “wearable device” or “wearable sensor” relates to miniature electronic devices that are worn by the user including those under, within, with or on top of clothing and are part of a broader general class of wearable technology which includes “wearable computers” which in contrast are directed to general or special purpose information technologies and media development. Such wearable devices and/or wearable sensors therefore form part of the wider PED grouping but are more directly associated with the user and may include, but not be limited to, smart watches, activity trackers, smart glasses, sensors, and immersive/non-immersive augmented reality systems.

A “fixed electronic device” (FED) as used herein and throughout this disclosure, refers to a wireless and/or wired device used for communications and other applications that requires connection to a fixed interface to obtain power. This includes, but is not limited to, a laptop computer, a personal computer, a computer server, a kiosk, a gaming console, a digital set-top box, an analog set-top box, an Internet enabled appliance, an Internet enabled television, and a multimedia player.

An “application” (commonly referred to as an “app”) as used herein may refer to, but is not limited to, a “software application”, an element of a “software suite”, a computer program designed to allow an individual to perform an activity, a computer program designed to allow an electronic device to perform an activity, and a computer program designed to communicate with local and/or remote electronic devices. An application thus differs from an operating system (which runs a computer), a utility (which performs maintenance or general-purpose chores), and a programming tools (with which computer programs are created). Generally, within the following description with respect to embodiments of the invention an application is generally presented in respect of software permanently and/or temporarily installed upon a PED and/or FED.

A “social network” or “social networking service” as used herein may refer to, but is not limited to, a platform to build social networks or social relations among people who may, for example, share interests, activities, backgrounds, or real-life connections. This includes, but is not limited to, social networks such as U.S. based services such as Facebook, Google+, Tumblr and Twitter; as well as Nexopia, Badoo, Bebo, VKontakte, Delphi, Hi5, Hyves, iWiW, Nasza-Klasa, Soup, Glocals, Skyrock, The Sphere, StudiVZ, Tagged, Tuenti, XING, Orkut, Mxit, Cyworld, Mixi, renren, weibo and Wretch.

“Social media” or “social media services” as used herein may refer to, but is not limited to, a means of interaction among people in which they create, share, and/or exchange information and ideas in virtual communities and networks. This includes, but is not limited to, social media services relating to magazines, Internet forums, weblogs, social blogs, microblogging, wikis, social networks, podcasts, photographs or pictures, video, rating and social bookmarking as well as those exploiting blogging, picture-sharing, video logs, wall-posting, music-sharing, crowdsourcing and voice over IP, to name a few. Social media services may be classified, for example, as collaborative projects (for example, Wikipedia); blogs and microblogs (for example, Twitter™); content communities (for example, YouTube and DailyMotion); social networking sites (for example, Facebook™); virtual game-worlds (e.g., World of Warcraft™); and virtual social worlds (e.g. Second Life™).

An “enterprise” as used herein may refer to, but is not limited to, a provider of a service and/or a product to a user, customer, or consumer. This includes, but is not limited to, a retail outlet, a store, a market, an online marketplace, a manufacturer, an online retailer, a charity, a utility, and a service provider. Such enterprises may be directly owned and controlled by a company or may be owned and operated by a franchisee under the direction and management of a franchiser.

A “service provider” as used herein may refer to, but is not limited to, a third party provider of a service and/or a product to an enterprise and/or individual and/or group of individuals and/or a device comprising a microprocessor. This includes, but is not limited to, a retail outlet, a store, a market, an online marketplace, a manufacturer, an online retailer, a utility, an own brand provider, and a service provider wherein the service and/or product is at least one of marketed, sold, offered, and distributed by the enterprise solely or in addition to the service provider.

A ‘third party’ or “third party provider” as used herein may refer to, but is not limited to, a so-called “arm's length” provider of a service and/or a product to an enterprise and/or individual and/or group of individuals and/or a device comprising a microprocessor wherein the consumer and/or customer engages the third party but the actual service and/or product that they are interested in and/or purchase and/or receive is provided through an enterprise and/or service provider.

A “user” as used herein may refer to, but is not limited to, an individual or group of individuals who monitor, acquire, store, transmit, edit, process and analyse information/data either locally or remotely to the user wherein by their engagement with a service provider, third party provider, enterprise, social network, social media etc. via a dashboard, web service, website, software plug-in, software application, graphical user interface etc. accesses and uses a PURDE-FRASAP according to an embodiment of the invention with respect to, for example, electronic content. This includes, but is not limited to, private individuals, employees of organizations and/or enterprises, members of community organizations, members of charity organizations, men, women, children, and teenagers. In its broadest sense the user may further include, but not be limited to, software systems, mechanical systems, robotic systems, android systems, etc. that may be characterised as having the ability to monitor, acquire, store, transmit, edit, process and analyse information/data and associate this to a field or fields within a PURDE-FRASAP according to an embodiment of the invention.

“User information” as used herein may refer to, but is not limited to, user behavior information and/or user profile information. It may also include a user's biometric information, an estimation of the user's biometric information, or a projection/prediction of a user's biometric information derived from current and/or historical biometric information.

“Electronic content” (also referred to as “content” or “digital content”) as used herein may refer to, but is not limited to, any type of content that exists in the form of digital data as stored, transmitted, received and/or converted wherein one or more of these steps may be analog although generally these steps will be digital. Forms of digital content include, but are not limited to, information that is digitally broadcast, streamed or contained in discrete files. Viewed narrowly, types of digital content include popular media types such as MP3, JPG, AVI, TIFF, AAC, TXT, RTF, HTML, XHTML, PDF, XLS, SVG, WMA, MP4, FLV, and PPT, for example, as as others, see for well example http://en.wikipedia.org/wiki/List_of_file_formats. Within a broader approach digital content mat include any type of digital information, e.g. digitally updated weather forecast, a GPS map, an eBook, a photograph, a video, a Vine™, a blog posting, a Facebook™ posting, a Twitter™ tweet, online TV, etc. The digital content may be any digital data that is at least one of generated, selected, created, modified, and transmitted in response to a user request, said request may be a query, a search, a trigger, an alarm, and a message for example.

Reference to “content information” as used herein may refer to, but is not limited to, any combination of content features, content serving constraints, information derivable from content features or content serving constraints (referred to as “content derived information”), and/or information related to the content (referred to as “content related information”), as well as an extension of such information (e.g., information derived from content related information).

Reference to a “document” as used herein may refer to, but is not limited to, any machine-readable and machine-storable work product. A document may be a file, a combination of files, one or more files with embedded links to other files, etc. The files may be of any type, such as text, audio, image, video, etc. Parts of a document to be rendered to an end user can be thought of as “content” of the document. A document may include “structured data” containing both content (words, pictures, etc.) and some indication of the meaning of that content (for example, e-mail fields and associated data, HTML tags and associated data, etc.). In the context of the Internet, a common document is a Web page. Web pages often include content and may include embedded information (such as meta-information, hyperlinks, etc.) and/or embedded instructions (such as Javascript, etc.). In many cases, a document has a unique, addressable, storage location and can therefore be uniquely identified by this addressable location such as a universal resource locator (URL) for example used as a unique address used to access information on the Internet.

“Document information” as used herein may refer to, but is not limited to, may include any information included in the document, information derivable from information included in the document (referred to as “document derived information”), and/or information related to the document (referred to as “document related information”), as well as an extensions of such information (e.g., information derived from related information). An example of document derived information is a classification based on textual content of a document. Examples of document related information include document information from other documents with links to the instant document, as well as document information from other documents to which the instant document links.

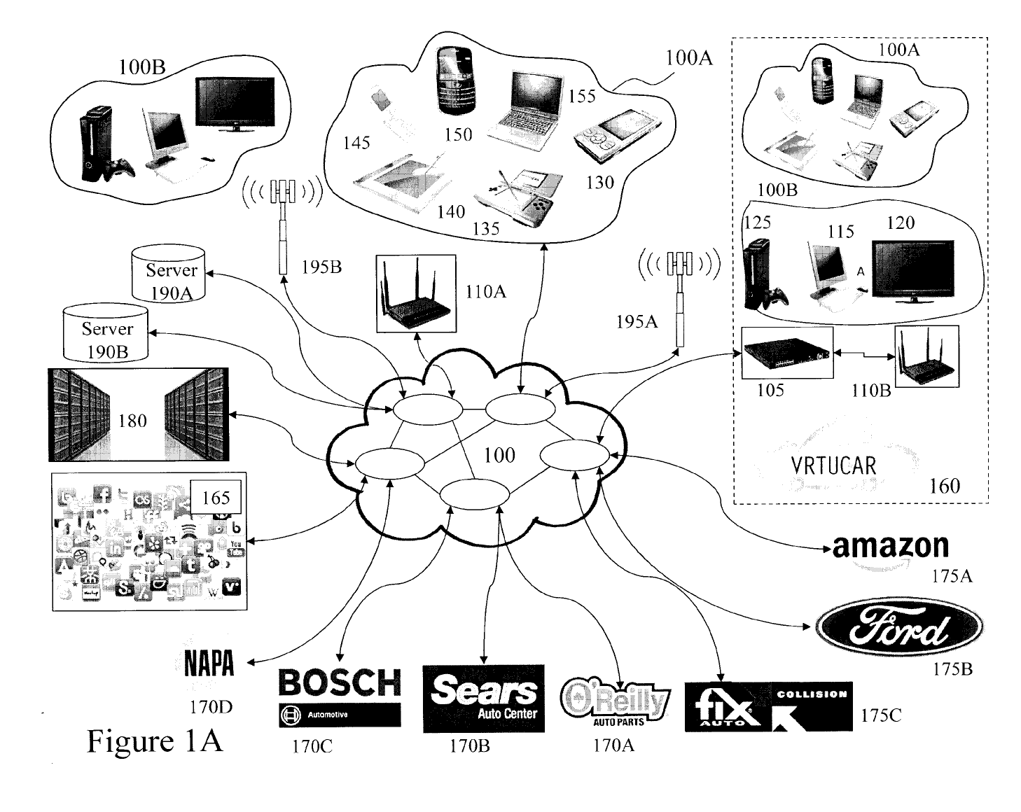

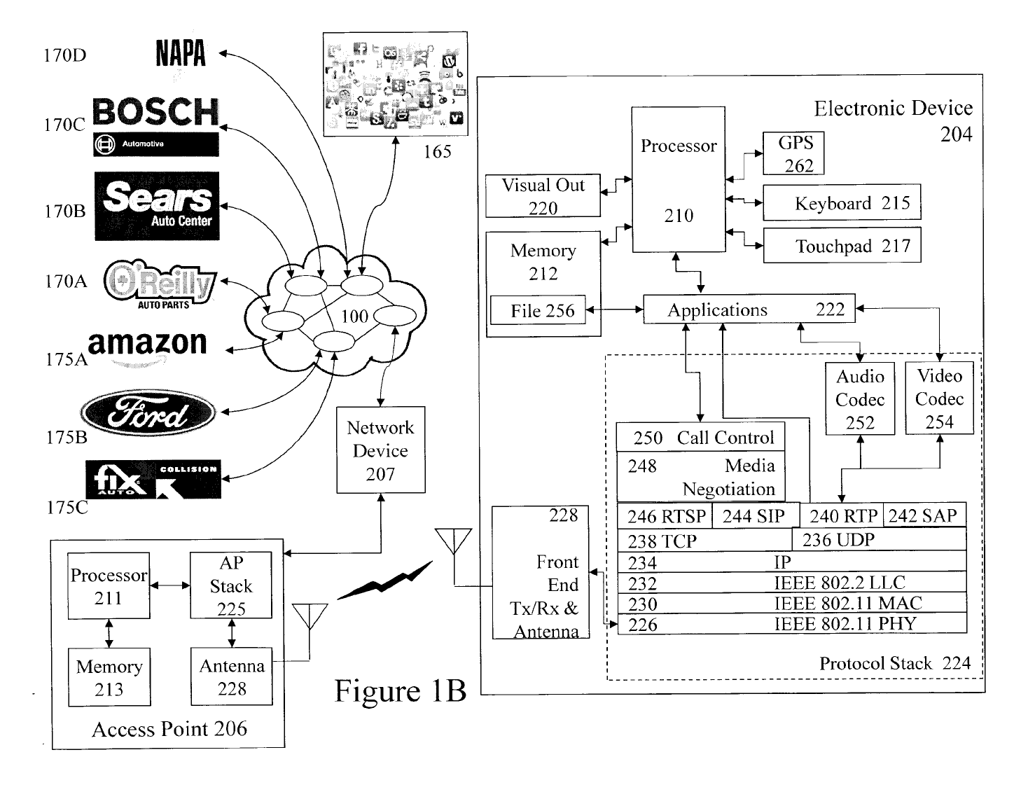

Referring to FIG. 1A there is depicted a network environment 100 within which embodiments of the invention may be employed supporting purchasing decision framework systems, applications and platforms (PURDE-FRASAPs) according to embodiments of the invention. Such PURDE-FRASAPs, for example supporting multiple channels and dynamic content. As shown first and second user groups 100A and 100B respectively interface to a telecommunications network 100. Within the representative telecommunication architecture, a remote central exchange 180 communicates with the remainder of a telecommunication service providers network via the network 100 which may include for example long-haul OC-48/OC-192 backbone elements, an OC-48 wide area network (WAN), a Passive Optical Network, and a Wireless Link. The central exchange 180 is connected via the network 100 to local, regional, and international exchanges (not shown for clarity) and therein through network 100 to first and second cellular APs 195A and 195B respectively which provide Wi-Fi cells for first and second user groups 100A and 100B respectively. Also connected to the network 100 are first and second Wi-Fi nodes 110A and 110B, the latter of which being coupled to network 100 via router 105. Second Wi-Fi node 110B is associated with Enterprise 160, e.g. VrtuCar, an Ottawa, Canada based car sharing enterprise, within which other first and second user groups 100A and 100B respectively are present. Second user group 100B may also be connected to the network 100 via wired interfaces including, but not limited to, DSL, Dial-Up, DOCSIS, Ethernet, G.hn, ISDN, MoCA, PON, and Power line communication (PLC) which may or may not be routed through a router such as router 105.

Within the cell associated with first AP 110A the first group of users 100A may employ a variety of PEDs including for example, laptop computer 155, portable gaming console 135, tablet computer 140, smartphone 150, cellular telephone 145 as well as portable multimedia player 130. Within the cell associated with second AP 110B are the second group of users 100B which may employ a variety of FEDs including for example gaming console 125, personal computer 115 and wireless/Internet enabled television 120 as well as cable modem 105. First and second cellular APs 195A and 195B respectively provide, for example, cellular GSM (Global System for Mobile Communications) telephony services as well as 3G and 4G evolved services with enhanced data transport support. Second cellular AP 195B provides coverage in the exemplary embodiment to first and second user groups 100A and 100B. Alternatively the first and second user groups 100A and 100B may be geographically disparate and access the network 100 through multiple APs, not shown for clarity, distributed geographically by the network operator or operators. First cellular AP 195A as show provides coverage to first user group 100A and environment 170, which comprises second user group 100B as well as first user group 100A. Accordingly, the first and second user groups 100A and 100B may according to their particular communications interfaces communicate to the network 100 through one or more wireless communications standards such as, for example, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, and IMT-1000. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access. Accordingly, portable electronic devices within first user group 100A may form associations either through standards such as IEEE 802.15 and Bluetooth as well in an ad-hoc manner.

Also connected to the network 100 are Social Networks (SOCNETS) 165, first automotive parts supplier 170A, e.g. O'Reilly Auto Parts; first automotive service enterprise 170B, e.g. Sears™ Auto Center; automotive parts manufacturer 170C, e.g. Bosch™ Automotive; second automotive parts supplier 170D, e.g. NAPA™ Auto Parts; online retailer 175A, e.g. Amazon™; automotive original equipment manufacturer 175B, e.g. Ford™; and second automotive service enterprise 175C, e.g. Fix Auto™; as well as first and second servers 190A and 190B together with others, not shown for clarity. First and second servers 190A and 190B may host according to embodiments of the inventions multiple services associated with a provider of rating systems and rating applications/platforms (PURDE-FRASAPs); a provider of a SOCNET or Social Media (SOME) exploiting PURDE-FRASAP features; a provider of a SOCNET and/or SOME not exploiting PURDE-FRASAP features; a provider of services to PEDS and/or FEDS; a provider of one or more aspects of wired and/or wireless communications; an Enterprise 160 exploiting PURDE-FRASAP features; license databases; content databases; image databases; content libraries; customer databases; websites; and software applications for download to or access by FEDs and/or PEDs exploiting and/or hosting PURDE-FRASAP features. First and second primary content servers 190A and 190B may also host for example other Internet services such as a search engine, financial services, third party applications and other Internet based services.

Accordingly, a consumer and/or customer (user) may exploit a PED and/or FED within an Enterprise 160, for example, and access one of the first or second primary content servers 190A and 190B respectively to perform an operation such as accessing/downloading an application which provides PURDE-FRASAP features according to embodiments of the invention; execute an application already installed providing PURDE-FRASAP features; execute a web based application providing PURDE-FRASAP features; or access content. Similarly, a CONCUS may undertake such actions or others exploiting embodiments of the invention exploiting a PED or FED within first and second user groups 100A and 100B respectively via one of first and second cellular APs 195A and 195B respectively and first Wi-Fi nodes 110A.

Now referring to FIG. 1B there is depicted an electronic device 204 and network access point 207 supporting PURDE-FRASAP features according to embodiments of the invention. Electronic device 204 may, for example, be a PED and/or FED and may include additional elements above and beyond those described and depicted. Also depicted within the electronic device 204 is the protocol architecture as part of a simplified functional diagram of a system 200 that includes an electronic device 204, such as a smartphone 155, an access point (AP) 206, such as first AP 110, and one or more network devices 207, such as communication servers, streaming media servers, and routers for example such as first and second servers 190A and 190B respectively. Network devices 207 may be coupled to AP 206 via any combination of networks, wired, wireless and/or optical communication links such as discussed above in respect of FIG. 1A as well as directly as indicated. Network devices 207 are coupled to network 100 and therein Social Networks (SOCNETS) 165, first automotive parts supplier 170A, e.g. O'Reilly Auto Parts; first automotive service enterprise 170B, e.g. Sears™ Auto Center; automotive parts manufacturer 170C, e.g. Bosch™ Automotive; second automotive parts supplier 170D, e.g. NAPA™ Auto Parts; online retailer 175A, e.g. Amazon™; automotive original equipment manufacturer 175B, e.g. Ford™; and second automotive service enterprise 175C, e.g. Fix Auto™; as well as first and second servers 190A and 190B together with others, not shown for clarity.

The electronic device 204 includes one or more processors 210 and a memory 212 coupled to processor(s) 210. AP 206 also includes one or more processors 211 and a memory 213 coupled to processor(s) 210. A non-exhaustive list of examples for any of processors 210 and 211 includes a central processing unit (CPU), a digital signal processor (DSP), a reduced instruction set computer (RISC), a complex instruction set computer (CISC) and the like. Furthermore, any of processors 210 and 211 may be part of application specific integrated circuits (ASICs) or may be a part of application specific standard products (ASSPs). A non-exhaustive list of examples for memories 212 and 213 includes any combination of the following semiconductor devices such as registers, latches, ROM, EEPROM, flash memory devices, non-volatile random access memory devices (NVRAM), SDRAM, DRAM, double data rate (DDR) memory devices, SRAM, universal serial bus (USB) removable memory, and the like.

Electronic device 204 may include an audio input element 214, for example a microphone, and an audio output element 216, for example, a speaker, coupled to any of processors 210. Electronic device 204 may include a video input element 218, for example, a video camera or camera, and a video output element 220, for example an LCD display, coupled to any of processors 210. Electronic device 204 also includes a keyboard 215 and touchpad 217 which may for example be a physical keyboard and touchpad allowing the user to enter content or select functions within one of more applications 222. Alternatively, the keyboard 215 and touchpad 217 may be predetermined regions of a touch sensitive element forming part of the display within the electronic device 204. The one or more applications 222 that are typically stored in memory 212 and are executable by any combination of processors 210. Electronic device 204 also includes accelerometer 260 providing three-dimensional motion input to the process 210 and GPS 262 which provides geographical location information to processor 210.

Electronic device 204 includes a protocol stack 224 and AP 206 includes a communication stack 225. Within system 200 protocol stack 224 is shown as IEEE 802.11 protocol stack but alternatively may exploit other protocol stacks such as an Internet Engineering Task Force (IETF) multimedia protocol stack for example. Likewise, AP stack 225 exploits a protocol stack but is not expanded for clarity. Elements of protocol stack 224 and AP stack 225 may be implemented in any combination of software, firmware and/or hardware. Protocol stack 224 includes an IEEE 802.11-compatible PHY module 226 that is coupled to one or more Front-End Tx/Rx & Antenna 228, an IEEE 802.11-compatible MAC module 230 coupled to an IEEE 802.2-compatible LLC module 232. Protocol stack 224 includes a network layer IP module 234, a transport layer User Datagram Protocol (UDP) module 236 and a transport layer Transmission Control Protocol (TCP) module 238.

Protocol stack 224 also includes a session layer Real Time Transport Protocol (RTP) module 240, a Session Announcement Protocol (SAP) module 242, a Session Initiation Protocol (SIP) module 244 and a Real Time Streaming Protocol (RTSP) module 246. Protocol stack 224 includes a presentation layer media negotiation module 248, a call control module 250, one or more audio codecs 252 and one or more video codecs 254. Applications 222 may be able to create maintain and/or terminate communication sessions with any of devices 207 by way of AP 206. Typically, applications 222 may activate any of the SAP, SIP, RTSP, media negotiation and call control modules for that purpose. Typically, information may propagate from the SAP, SIP, RTSP, media negotiation and call control modules to PHY module 226 through TCP module 238, IP module 234, LLC module 232 and MAC module 230.

It would be apparent to one skilled in the art that elements of the electronic device 204 may also be implemented within the AP 206 including but not limited to one or more elements of the protocol stack 224, including for example an IEEE 802.11-compatible PHY module, an IEEE 802.11-compatible MAC module, and an IEEE 802.2-compatible LLC module 232. The AP 206 may additionally include a network layer IP module, a transport layer User Datagram Protocol (UDP) module and a transport layer Transmission Control Protocol (TCP) module as well as a session layer Real Time Transport Protocol (RTP) module, a Session Announcement Protocol (SAP) module, a Session Initiation Protocol (SIP) module and a Real Time Streaming Protocol (RTSP) module, media negotiation module, and a call control module. Portable and fixed electronic devices represented by electronic device 204 may include one or more additional wireless or wired interfaces in addition to the depicted IEEE 802.11 interface which may be selected from the group comprising IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, DSL, Dial-Up, DOCSIS, Ethernet, G.hn, ISDN, MoCA, PON, and Power line communication (PLC).

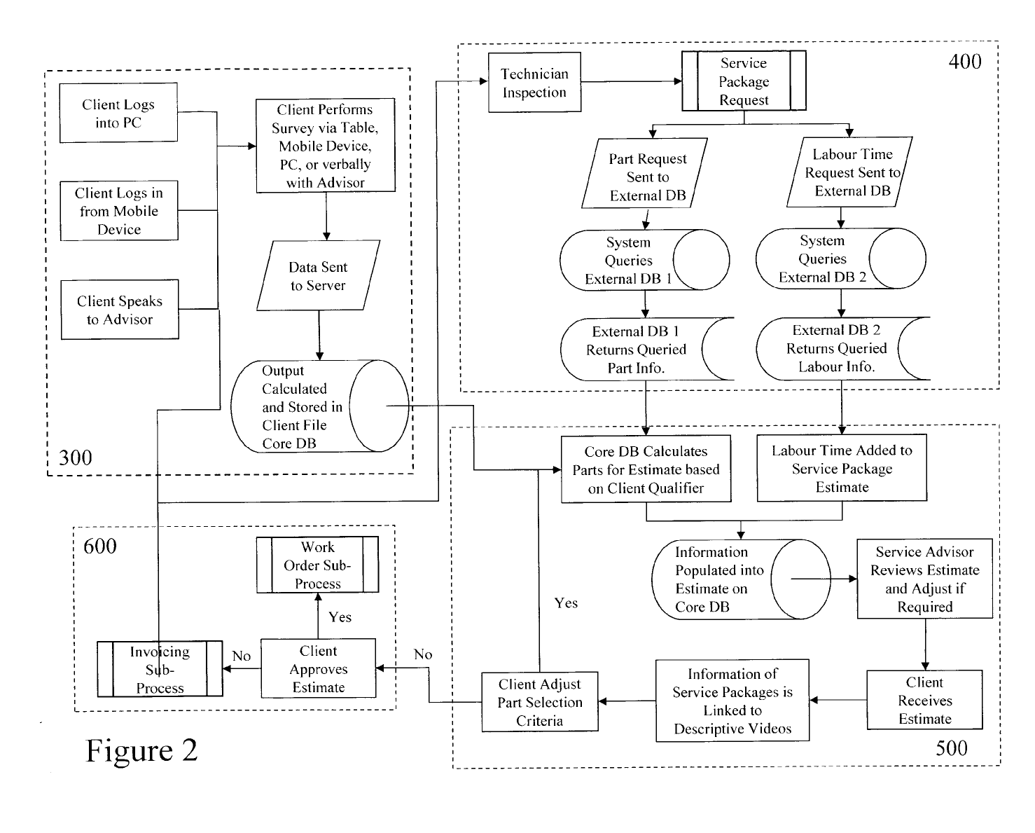

Now referring to FIG. 2 there is depicted an exemplary flow chart for a software application supporting PURDE-FRASAPs according to an embodiment of the invention. As depicted the exemplary flow of the software application comprises a series of modules:
First module 300 relating to a client driven search and decision process;
Second module 400 relating to a technician inspection search and decision process;
Third module 500 relating to client decision process; and
Fourth module 600 client driven post-purchasing decision process.

It would be evident to one skilled in the art that other process flows may be implemented according to other embodiments of the invention and that the process flow depicted in FIG. 2 may be partitioned into different modules without departing from the scope of the invention.

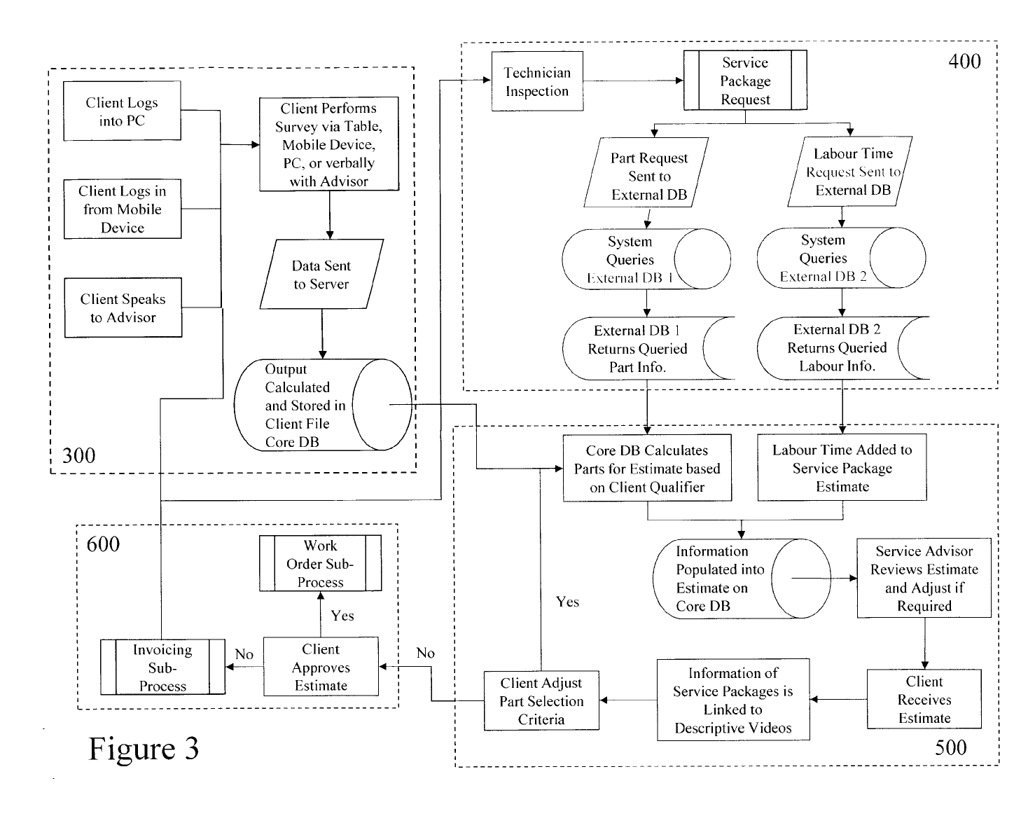

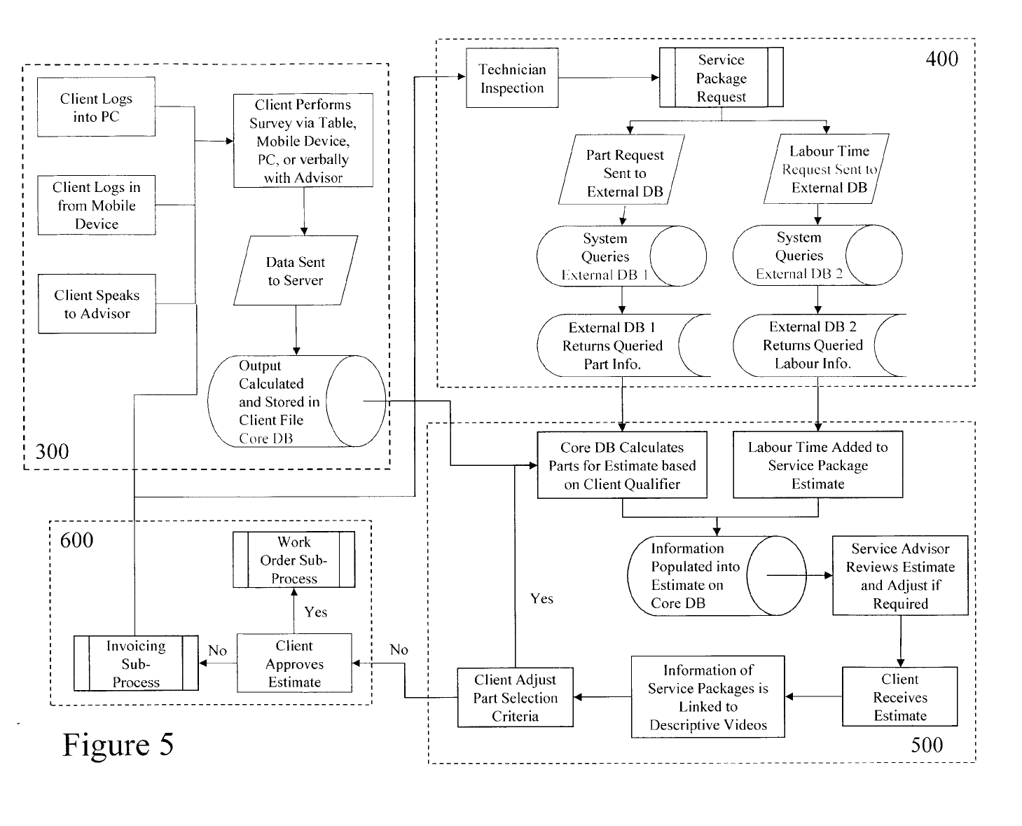

Now referring to FIG. 3 there is depicted first module 300 relating to a client driven search and decision process within a software application supporting PURDE-FRASAPs according to an embodiment of the invention. Accordingly, there are presented first to sixth steps 310 to 360. Within first to third steps 310 to 330 the user accesses the PURDE-FRASAP by either logging in via their PC, an example of a FED, logging in via their smartphone, an example of a PED, or speaking to an advisor respectively. Speaking to an advisor may be via a PED, conventional telephone, or the user's PED/FED via a Voice-over-Internet Protocol (VOIP) service such as Skype™ or Vonage™ for example. From either of these access steps first module 300 proceeds to step 340 wherein the user undertakes a search and decision process, e.g. searching for automotive parts and/or automotive services via the PURDE-FRASAP according to an embodiment of the invention. Based upon the user's search/decision making process a set of client driven data is generated and sent to a remote server in step 350. Next in step 360 the client driven data is processed to establish an output data set which is stored within a client file within a core database (Core DB) for subsequent retrieval and use. From step 360 in first module 300 the process proceeds to step 510 in third module 500 as described below in respect of FIG. 5.

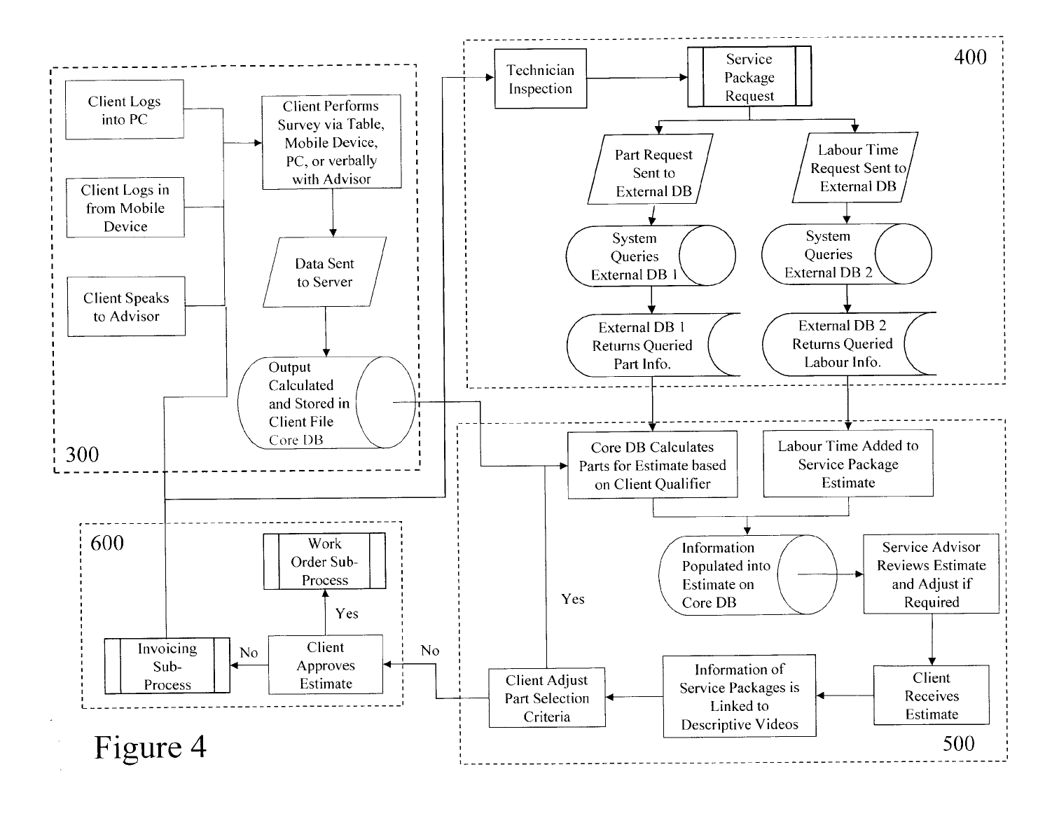

In the application of a PURDE-FRASAP according to an embodiment of the invention then the user is presented as making a search and decision process, e.g. searching for automotive parts and/or automotive services via the PURDE-FRASAP. Within such an application the user may also seek to obtain the requisite activity, e.g. service, maintenance, or repair, on their automotive, through a third party service provider such as an automotive dealership, a local mechanic, collision repair service, etc. Accordingly, in this instance the user exploits second module 400 as depicted in FIG. 4 with an exemplary flow within a software application supporting PURDE-FRASAPs according to an embodiment of the invention. It would be evident that in a range of scenarios such as heating, plumbing, automotive, air conditioning, electrical, etc. that the user seeking to make the balanced informed decision does not have the requisite skills and hence exploits the services of a technician in the related field to give them an initial requirement. However, rather than simply accept the technician's prepared requirements for parts and labour the user wishes to make some adjustments based upon their circumstances and their wider viewpoint of the requirements than either the technician has.

As depicted this second module 400 begins with process step 410 wherein a technician inspection is performed. From this step the technician establishes a service package request, e.g. replace the brakes and tires on a vehicle. This service package request triggers two parallel threads within the second module 400 depicted by first thread comprising steps 430 to 450 and second thread comprising 460 to 480 respectively. Considering initially the first thread then as depicted:
Step 430—wherein a parts request with respect to the service package is generated and communicated to an external database;
Step 440—wherein the system queries the external database for parts matching the parts request transmitted in step 430; and
Step 450—wherein the external database returns part information based upon the parts request and the query.

Similarly, the second thread as depicted relates to labour and comprises:
Step 460—wherein a labour request with respect to the service package is generated and communicated to an external database;
Step 470—wherein the system queries the external database for labour tasks associated with the labour request transmitted in step 460; and
Step 480—wherein the external database returns labour information based upon the parts request and the query.

Now referring to FIG. 5 the third module 500 is depicted as comprising first to seventh steps 510 to 570 respectively. Third module 500 is linked to the first module 300 such that after step 360 as depicted in FIG. 3 the process proceeds to step 510. Third module 500 is also linked to the second module 400 such that step 450 as depicted in FIG. 4 links to step 510 and step 480 as depicted in FIG. 4 links to step 520. As depicted therefore third module 500 comprises:
Step 510 wherein the Core Database (Core DB) storing the output in step 360 in first process 300 calculates what parts to use within the estimate based upon the qualifier's selected by the user;
Step 520 wherein the labour elements established in step 480 of second process 400 are added to the estimate;
Step 530 wherein the information from steps 510 and 520 is populated into the estimate on the Core DB;
Step 540 wherein a service advisor reviews the estimate and makes adjustments a necessary, such that for example, whilst the user selected new brake pads and new tires they were not aware of the requirement to also replace brake caliper pins based upon the age of their vehicle or in light of a recall or that the labour estimate for replacing brake pads can be adjusted as the tires are being removed already for replacement;
Step 550 wherein the advisor approved estimate is released to the user;
Step 560 wherein the user receives the estimate based upon either their data entry or that from the technician inspection together with informational audiovisual content that may be appropriate to explain the required work and/or provide the user with an installation guide for example; and
Step 570 wherein the user may accept the estimate or may wish to make adjustments wherein based upon these decisions the process either proceeds to fourth module 600 or loops back to step 510 wherein the modified parts are used within the building of a modified quotation to the user.

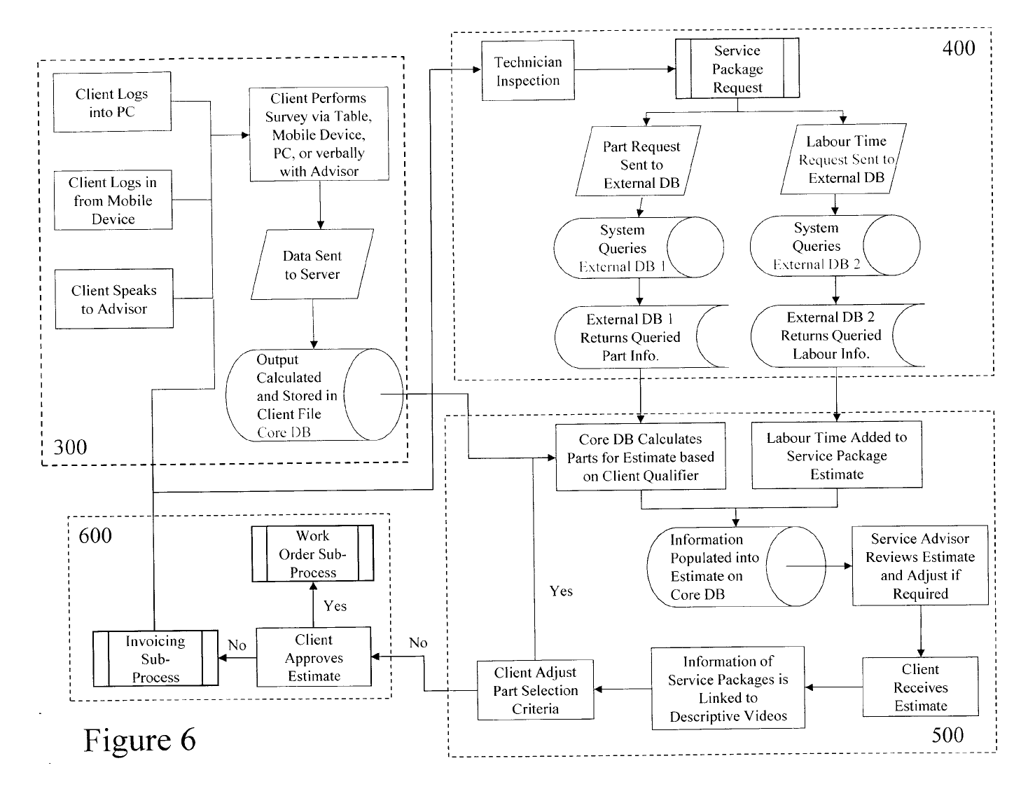

Now referring to FIG. 6 the fourth module 600 is depicted as comprising first to third steps 610 to 630 respectively. Fourth module 600 is linked to the third module 500 such that after step 570 as depicted in FIG. 5 with a user approval of the initial or revised estimate the process proceeds to step 610. As depicted therefore fourth module 600 comprises:
Step 610 wherein the user formally approves or rejects the estimate;
Step 620 wherein the user has approved the estimate thereby triggering purchase of the parts and/or scheduling of the technician to perform the work; and
Step 630 wherein the user rejects the estimate thereby halting all sub-processes wherein the process loops back to either step 330 in first module 300 or step 410 in second module 400 in order to loop back around and seek an alternate fulfilment to the user's requirement.

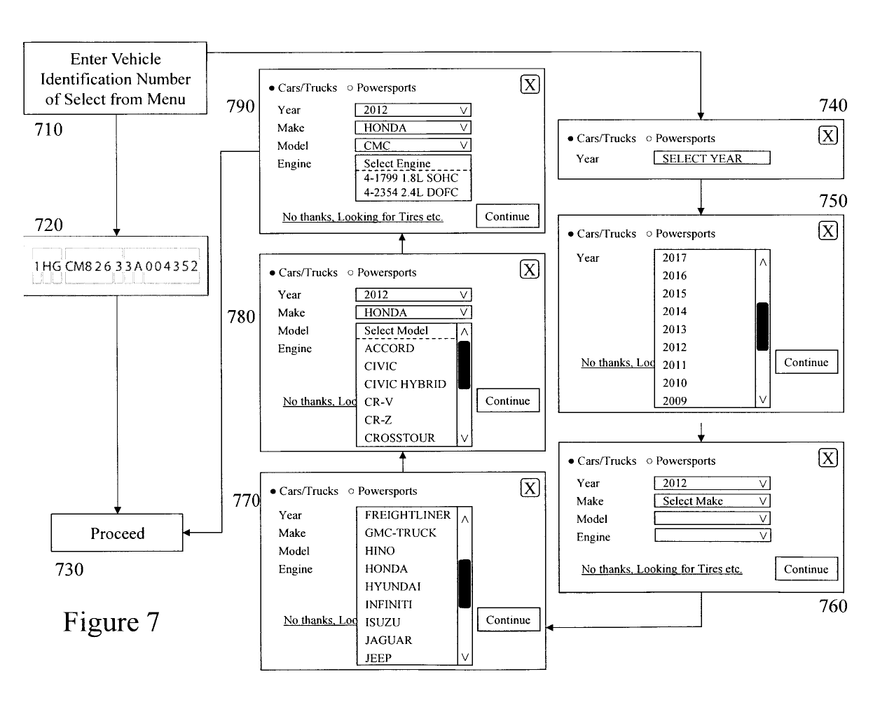

FIG. 7 depicts a context determination process for a PURDE-FRA SAP according to an embodiment of the invention as depicted with respect to an automotive requirement. Optionally, a PURDE-FRASAP may be configured and accessed by users for a single category of service/product or alternatively the PURDE-FRASAP may be configured and accessed by users for multiple categories of service and/or product. As depicted the process begins at step 710 wherein the user selects to either enter a vehicle identification number (VIN) or select the vehicle to which the activity relates through a series of menus, depicted as step 740 to 790 respectively. Upon a determination to enter the VIN the process proceeds to step 720 wherein the user enters the VIN which is then parsed to extract the manufacturer identifier, second character, country of origin, first character, and vehicle details, fourth to eighth characters with their associated check digit in the ninth character location. Once, the VIN has been parsed and validated the process proceeds to step 730 otherwise it loops around until a valid VIN is entered or the user exits the PURDE-FRASAP.

With the menu option the user is guided through a sequence comprising:
Step 740 wherein the user selects to establish a car/truck rather than a power sport vehicle such as motorcycle, all-terrain vehicle (TV), quad bike, etc.;
Step 750 wherein the user selects the year of manufacture for their vehicle as popular models are re-designed and re-specified throughout their period of availability;
Step 760 wherein the user selected “2012” that refines or filters subsequent lists;
Step 770 wherein the user selects the manufacturer, Honda™;
Step 780 wherein the user selects the model by that manufacturer, e.g. Civic; and
Step 790 wherein the user selects in this instance engine to reflect the different specifications simultaneously offered, in this case a 1.8 liter single overhead camshaft (SOHC) or 2.4-liter double overhead camshaft (DOHC). Alternatively, the user may select grade of vehicle such as LX, EX, etc.

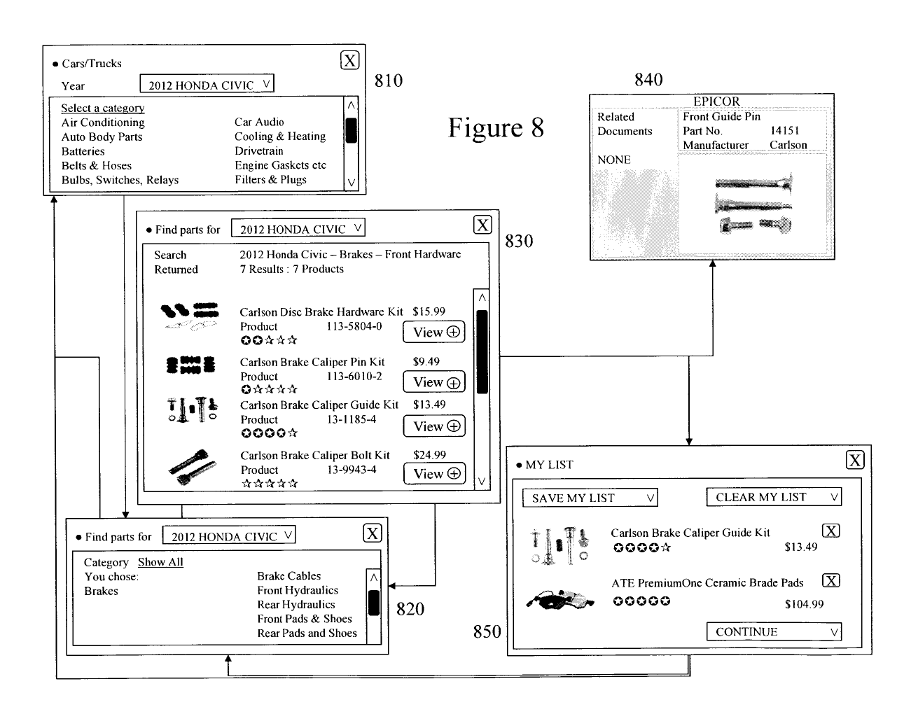

Accordingly, within the embodiment of the invention the process depicted in FIG. 7 establishes a context for the user's activity against which other actions subsequently are defined. In an alternate embodiment relating to plumbing the user may select though a similar menu sequence that the plumbing activity is indoor, in the bathroom, and is replacing the shower closet. Accordingly, as depicted in FIG. 8 the user can now perform a contextually driven decision making process within a PURDE-FRASAP according to an embodiment of the invention. As such FIG. 8 depicts a process comprising:
Step 810 wherein the user selects a category of activity, e.g. they select “Brakes” from the displayed list of activities that are contextually defined by their selection of the “2012 Honda Civic”;
Step 820 wherein the user selects a sub-category of activity, e.g. they select “Front Brake Hardware” from the displayed list of activities that are contextually defined by their selection of the “2012 Honda Civic” and category of “Brakes”;
Step 830 wherein the user is presented with options in respect of the parts relating to their category and sub-category within the overall context;
Step 840 wherein the user has selected a “front guide pin” within the options presented in step 830 and elected to view the detailed information which in this instance is an image of the product but may include, images, dimensions, audiovisual segments, electronic documents etc.; and
Step 850 wherein the user has selected brake caliper guide pin kit and ceramic brake pads.

From step 830 if the user does not find what they wanted then they loop back to step 820. Similarly, from building their parts list in step 850 they can loop back to step 810 or 820. In this manner the user can establish a parts list associated with multiple activities either related or unrelated.

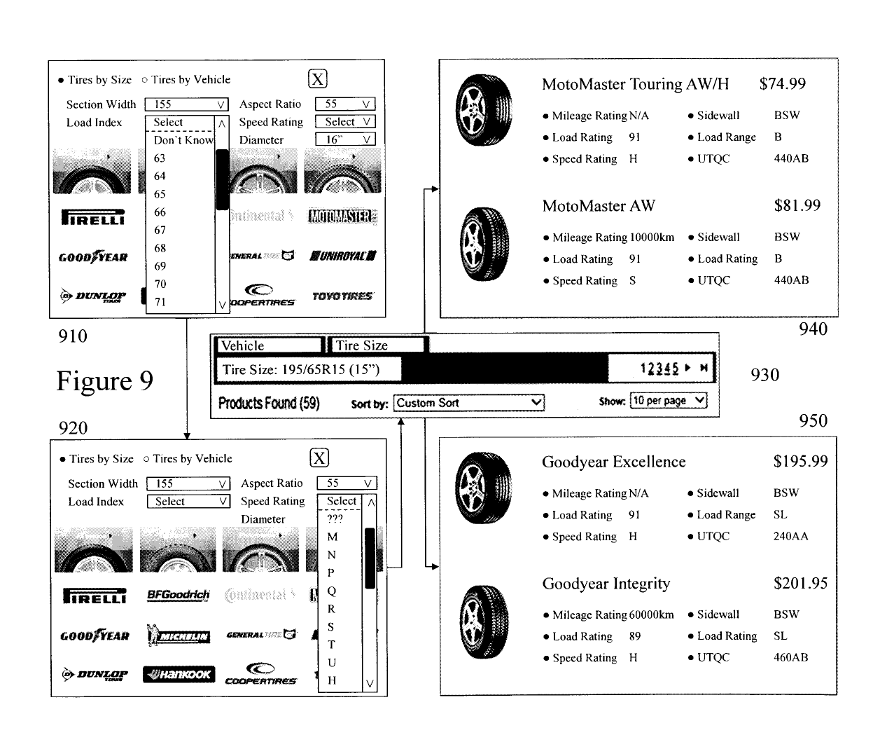

Now referring to FIG. 9 there is depicted a contextually driven decision making process within a PURDE-FRASAP according to an embodiment of the invention, but now relating to tires. Accordingly, the process comprises:
Step 910 wherein the user has reached part way through an extended process, the earlier steps of which have been omitted for clarity but the user selected a tire width of 155, an aspect ratio of 55 and hub diameter 16″. Now within step 910 they are being asked to select the load index of the tire where this defines the tires weight carrying ability, which as depicted is a numeric scale between 63 and 90 but the list can be scrolled to higher values. A load index of 90 corresponds to 600 kg (approx. 1325 pounds) for that tire;
Step 920 wherein the user is now asked to select a speed rating of the tire, wherein these are depicted as characters according to a standard;
Step 930 wherein having selected “Don't Know” in each of steps 910 and 920 they are presented with 59 products within the already restricted category of 195/65 15″ tires;
Step 940 wherein the user is presented with lowest cost tire options such as the MotoMaster Touring AW/H for $74.99 which has a load index of 91, a speed rating of H, and a non-specified mileage rating; and

Step 950 Step 940 wherein the user is presented with highest cost tire options such as the Goodyear™ Integrity for $201.99 which has a load index of 89 (lower than the MotoMaster Touring Aw/H), a speed rating of H, and an 80,000 km (approx. 50,000 miles).

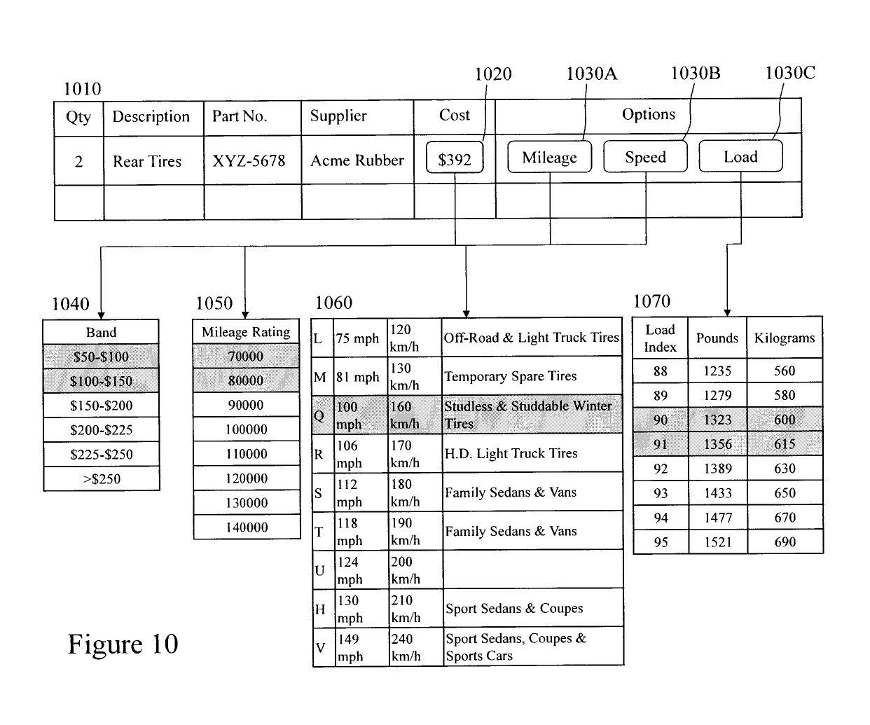

Accordingly, consider the instance that the tires were part of an overall estimate relating to a vehicle where the user was replacing tires and brakes but having selected the various parts is not seeking to understand how they may adjust the overall parts list to, for example, lower cost without reducing overall performance. In another instance, for example, the user may be changing away from winter tires and requires new tires but in 6 months is ending the lease and anticipates only 4,000-5,000 km of use (approx. 2,500-3,100 miles). Further, by virtue of their vehicle only be a 4-door sedan (Honda Civic) their loading is light unlike perhaps if it was a sports utility vehicle (SUV) and their typical travel within a city. Accordingly, referring to FIG. 10 there is depicted a contextually driven balanced purchasing decision variation methodology within a PURDE-FRASAP according to an embodiment of the invention.

As depicted table 1010 represents part of a parts list presented to a user identifying 2 Rear Tires as part of the list supplied by Acme Rubber with part number XYZ-5678 at a cost of $392, i.e. $196 (or $195.99 normally) each. Also presented to the user are first button 1020 and second to fourth buttons 1030A to 1030C respectively. Selection of each triggers a pop-up menu for selecting an adjustment in the specification of the tire. Accordingly:

First button 1020 allows the cost range to be established by selecting one or more elements in second table 1040, such that for example the user wants to see options within the price range $50-$150;

Second button 1030A allowing the user to select mileage ratings of 70,000 and 80,000 either in isolation of an action through first button 1020 or in combination with it;

Third button 1030B allowing the user to select a speed rating of Q which relates to a maximum speed of 160 km/h (100 mph) either in isolation or in combination with others; and

Fourth button 1030C allowing the user to select a load rating of 90/91 equivalent to 600/615 kg per tire (1323-1356 pounds).

As the user has previously established the context, e.g. 2012 Honda Civic, then fourth button 1030C may be restricted to depict only those options exceeding the rated weight per wheel from the manufacturers guide. Optionally, the filtering process applied may take each of the options in respect of second to fourth buttons 1030A to 1030C as a minimum requirement such that, for example, if a 120,000 km mileage rated tire was available at $99.99 it would be depicted as an alternative. Similarly, with respect to other options if selected.

The mileage rating in the instance of tires is a measure of lifetime of the product which may be a factor in many aspects of decisions made by users. Alternatively, a warranty may be an issue such that, for example, a user may wish to see the impact of trading hot water boiler warranty on the cost of renovating the hot water within their residence and as such can dynamically make an adjustment and see the potential impact to the overall bill of parts.

In other embodiments of the invention the selection of an alternate part within a list of parts may trigger adjustments in others in order that the total parts list fulfils the desired task for the user. For example, if they have selected a hot water system with boiler, tap, copper pipe and copper fittings and modify the pipe to PVC then all of the fittings require adjustment if they accept that the maximum water temperature can now be only 55° C. (130° F.). However, this may also change the time required to assemble for a plumber as perhaps solder fittings are replaced with glued fittings or compression fittings and these take less time/more time respectively.

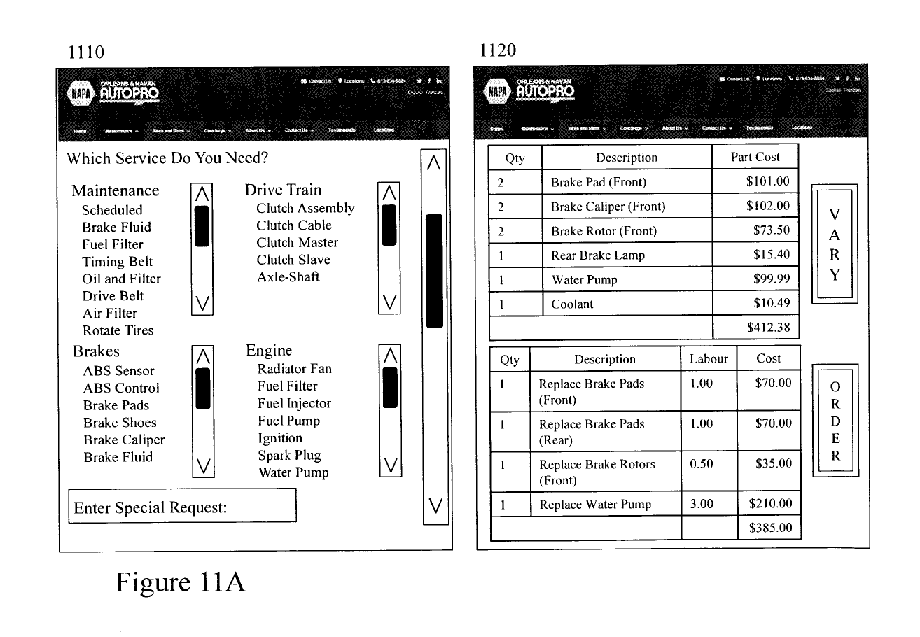

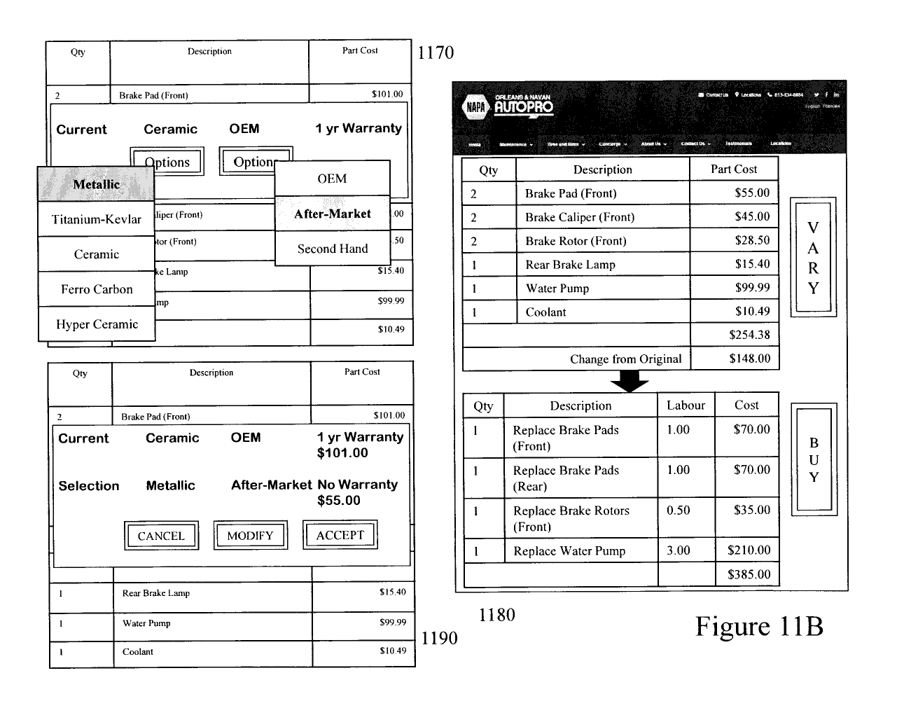

Now referring to FIGS. 11A and 11B there are depicted images relating to a balanced purchasing decision variation methodology within a PURDE-FRASAP according to an embodiment of the invention. As depicted in FIG. 11A a user accesses a first webpage 1110 relating to a provider of maintenance and repair services relating to motor vehicles wherein they are provided with a standard list of services relating to their vehicle together with a field for entering a special request. Based upon selection of an item, e.g. Brake Pad(s) Replacement and a subsequent selection of “Front” (not shown for clarity) and knowledge of the vehicle of the user, for example through a selection process such as described supra or through their logging into the web service thereby retrieving data associated with their account. Such a login process may for example be via a social media account of the user as known in the art or through alternate methods such as username/password etc. Accordingly, the system retrieves a list of parts based upon a standard service menu and a schedule of associated labour with the requested service which are displayed in second webpage 1120. In this instance the “Brake Pad(s) Replacement” has triggered a list of front brake pads, front brake calipers, and front brake rotors. Equally, a special request of new water pump has triggered the listing of a water pump and coolant.

The provider of maintenance and repair services may have a small number of standard parts suppliers whose data is retrieved in order to populate the parts list 1130 with pricing information and their own maintenance task list used to populate the labour list 1140. The user is also presented with “Vary” 1150 and “Order” 1160 buttons with respect to the displayed part and labour information. If they select “Order” 1160 then they are processed through a scheduling process wherein factors including, but not limited to, part availability, user availability, technician availability, etc. are employed to provide the user with a scheduled appointment to have their vehicle worked upon. In the instance that the user selects “Vary” 1150 then they are presented with a variant of second webpage 1120 wherein the user can select a part listed, e.g. Brake Pad(Front), leading to a modified display window such as that depicted in first image 1170 in FIG. 11B wherein additional information is presented relating to the current part, e.g. “Ceramic OEM 1 yr. Warranty” together with available options in respect of modifying the part. In this instance the user may select the type of brake pad, e.g. metallic, titanium-Kevlar™, ceramic, ferro carbon, and hyper ceramic. They are also offered in this instance different categories such as OEM, After Market, and Second Hand. Accordingly, if the user as indicated selects Metallic and After Market then the display changes to second image 1190 based upon the system searching for alternate parts that meet these criteria and now the user can see that such a part alternative is $55 versus the original $101 but offers no warranty.

Accordingly, through this process the user may make informed decisions as to the balance between cost, performance, warranty etc. in respect of their parts. In instances that the alternate part is incompatible with other elements of the original parts list then this fact may be either highlighted giving the user the ability to accept additional changes or be performed automatically. In second image 1190 the user may cancel, modify or accept the change. If they accept then the third image 1180 is provided to user showing the modified part list and labour listing. Just as other parts may adjust through the selection of a modification of a part within the bill of materials then some may trigger an adjustment in the labour portion. In this instance the selected alternate parts lower the part cost by $148.

It would be evident that the simplified part list presented in FIGS. 11A and 11B may be presented in other aspects of the invention or alternatively a more detailed parts list may be provided as discussed and depicted in respect of other aspects of the invention in FIGS. 1 to 10 within an embodiment of the invention as presented with respect to FIGS. 11A to 11B.

It would be evident to one of skill in the art that the process described and depicted in respect of FIGS. 11A and 11B may provide a manufacturer of parts with lost sales data. Accordingly, the data acquired by embodiments of the invention may allow a manufacturer to establish purchasing/maintenance patterns for parts, sub-assemblies, etc. by part, vehicle make, vehicle type, year of manufacture etc. Equally, a service chain may establish a common trend with respect to its customers and may make an adjustment in the standard parts associated with specific menu driven maintenance and/or repair activities. In other embodiments of the invention the lack of a specific part within the parts supplied by a manufacturer associated with the maintenance/repair facility may be identified as an issue arising with a particular make, model, year etc. becomes evident thereby allowing the manufacturer to establish a part earlier than perhaps would have been the case.

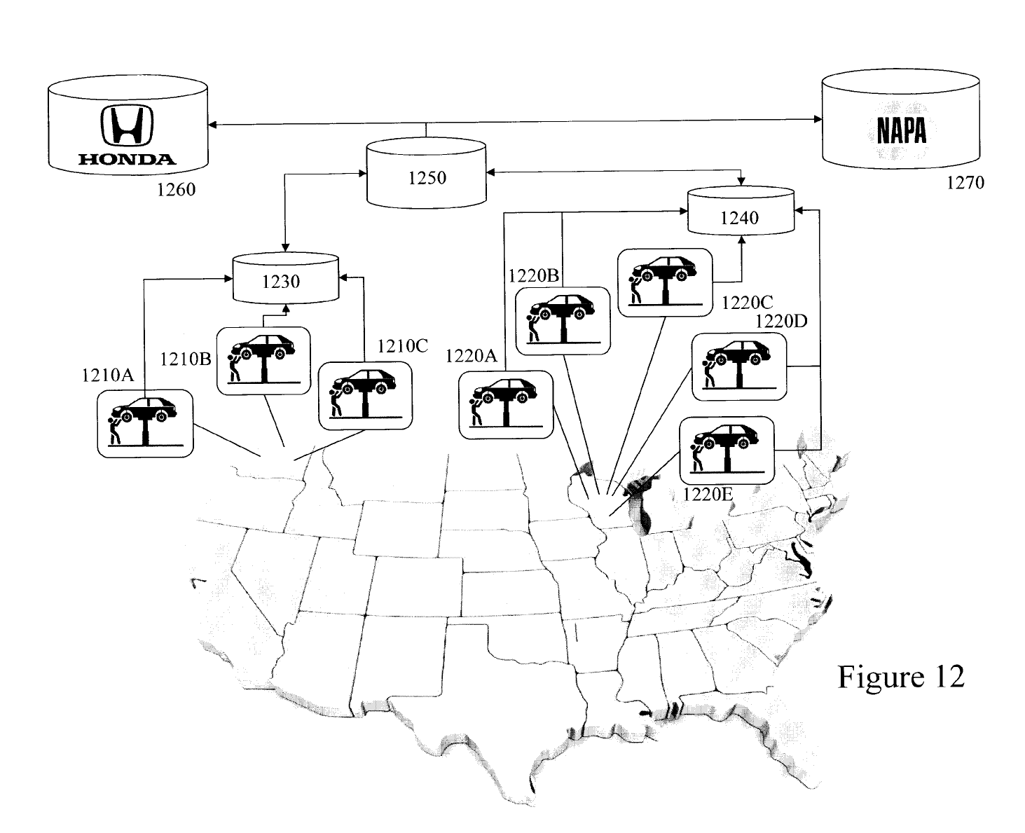

Referring to FIG. 12 there is depicted schematically the creation of a knowledge base through aggregation of data obtained/derived through purchasing decision framework systems, applications and platforms (PURDE-FRASAPs) according to an embodiment of the invention. Accordingly, as depicted a first set of service locations 1210A to 1210C in Washington state in the United States exploit PURDE-FRASAPs which communicate with a first local server 1230 and therein to a remote server 1250. Similarly, a second set of service locations 1220A to 1220E in Wisconsin state communicate with a second local server 1240 and therein to the remote server 1250. Also coupled to the remote server 1250 are manufacturer server 1260, e.g. Honda, and parts supplier server 1270, e.g. NAPA. Accordingly, as users, both vehicle owners and service centers, access and employ the PURDE-FRASAP according to an embodiment of the invention then data is aggregated from a larger number of users rather than that experienced by a single service location, for example. Accordingly, within the database associated with the PURDE-FRASAP a service center in Green Bay, Wis. (e.g. a service location within the second set of service locations 1220A to 1220E) may search for “2008 Honda Civic” and establish that there are records for 100 vehicles within 10 different service locations within a predefined boundary, e.g. “920” area code.

A user may then query “Ball Joint” within an analytics suite associated with the PURDE-FRASAP database(s) or accessing them through third-party software tools. Accordingly, this query yields the summary data within Table 1.

TABLE 1
Example Data for 2008 Honda Civic Ball
Joint Replacements within Area Code 920

| | | 1^{st} Ball Joint | | |
|---|---|---|---|---|
| Mileage Band | Qty | Replacement | | Comments |
| 80,000 | 3 | | | |
| 90,000 | 10 | | | |
| 100,000 | 10 | 10 | | |
| 110,000 | | | | |
| 120,000 | 4 | 4 | @100,000 | |
| . . . | | | | |
| 210,000 | 3 | 3 | @100,000 | 1 replace again @ 170,000 |
| | | | | 1 replaced again @ 195,000 |

Accordingly, based upon this data analysis the PURDE-FRASAP allows the service location user to predict/analyse trends of repairs and create a knowledge base of common repairs for specific concerns. Furthermore, the PURDE-FRASAP can create a forecasting model for suppliers and measure the efficacy of quality on durability of parts. For example, it is evident from Table 1 that one “2008 Honda Civic” reached 210,000 km with a single ball joint replacement. Analysis of that vehicle record indicates that the replacement was a specific brand, e.g. Brand X. Accordingly, the repair options presented to a user can be modified to reflect such data analytics such that a subsequent vehicle owner may be advised that whilst “Brand Y” costs $Y they will need replacing by 200,000 km whereas “Brand X” costing $X would not need replacing by 200,000 km together with labour costs of $Z thereby actually offering the vehicle owner a lower cost of ownership. Additionally, the choice of brand and quality can create trends and analytic measures valuable to manufacturers and to suppliers as well as indicating regional/seasonal variations that may be less evident otherwise.

In many instances, such as that presented supra in respect of Honda Civic servicing the manufacturer may have a standardized service package framework meaning that a left front lower ball joint cannot be a right side lower ball joint. However, non-Honda service locations may have a service heading such as “Replace lower ball joint(s)” which implies both front and/or rear. As all shop label their service packages differently, this makes it virtually impossible to accurately develop analytics. However, as even non-manufacturer based service locations exploiting PURDE-FRASAP access and exploit standardized service packages these differences and disparities can be reduced or eliminated thereby allowing PURDE-FRASAPs the ability to create service excellence standards for the industry so as to protect customers of duplicated servicing.

It would be evident that such data analytics and analysis can become not only valuable data for service locations, parts manufacturers and vehicle manufacturers but also online retail services such as autoTRADER™ where the analytics of vehicle type with mileage, region etc. may provide users with a projected 1 year/2-year service cost based upon the user's projected annual mileage. Such projections may be automatically provided based upon additional analytics such as average mileage of users within buyer demographics or they may be provided based upon user selections/decisions. Accordingly, the user may by varying, for example, age of the vehicles searched and their mileage establish a cost of ownership that is acceptable to them with respect to anticipated service costs etc. derived from analysis of the PURDE-FRASAP database(s).

Within embodiments of the invention the system may schedule a technician to perform a particular maintenance/repair task with a fixed cost labour element to the customer. Subsequently based upon the fact that the technician enters start/finish times for the maintenance/repair task via a terminal then the system may establish an efficiency rating for technicians against the different maintenance/repair tasks. Subsequently, when that maintenance/repair task is scheduled the system will seek to assign a technician with a high efficiency, e.g. a low percentage calculated as average time to complete divided by assigned time, rather than one with a low efficiency. As such the system may adjust options to the user for the schedule or advise the staff at the maintenance/repair facility that the specified technician is scheduled to this task.

It would also be evident that embodiments of the invention may establish a profile relating to the user (customer) based upon their activities and purchasing. Accordingly, a maintenance/repair facility may offer benefits to its customers who regularly maintain, up-specify etc. Such benefits may include loan car, shuttle, preferential maintenance scheduling, early drop-off for maintenance/repair activities etc. In contrast, a customer who regularly does not perform all of the suggested maintenance/repair tasks or reduces the quality of parts may not be as attractive a client and hence not be offered such benefits or may receive additional contacts advising them that they are invalidating warranty on their vehicle, incurring increased running costs etc.

It is also contemplated and understood that information relating to components to be acquired, repaired or replaced may be entered using a method or methods not described above. It should be realized that there are many other acceptable methods of entering such information into the system of the present invention that would be familiar to one skilled in the art and may be employed herein. By whatever method used, each component of the equipment that must be acquired, repaired or replaced is entered into the system.

In association with obtaining information regarding a component to be replaced, the system may optionally identify the entered component in various ways. For example, once the user has entered, selected, or otherwise confirmed a component to be replaced, the system may display a description of the component. The component description may include various information, such as, for example, the location of the component, the function of the component, and other components that interact with and/or may also have to be repaired or replaced. In conjunction with the component description, or alternatively thereto, the system may display an image of the component, such as a photograph or a drawing thereof. The image may be the actual component, or be representative of the component. Any such description or image of a component may be presented on the same web page where the component information is entered. In such a case, the information and/or image may be presented in a separate and controllable window, as an overlay, or by any of various other known techniques. Prior to proceeding to the next step of the repair estimate preparation process, the system may also display a list of all components to be repaired or replaced that have been entered by the user.

Subsequent to, or in conjunction with, receiving the identity of a component to be replaced, the system of the present invention retrieves data relating thereto that will be necessary for preparing the estimate. This data may include the cost of the component to be replaced, as well as the cost of any ancillary items (e.g., fasteners, gaskets, etc.) required thereby and not included with the component. The component cost(s) may be based on the OEM's recommended cost, or on virtually any other base cost deemed appropriate for use in calculating the estimate. Other data that may be retrieved will typically include a standard labor time for replacing the component, which is also typically established by the manufacturer of the equipment. The retrieved data will also typically include a labor rate for replacing the component(s). The labor rate may a national average labor rate, or a labor rate that is more accurately representative of repair facilities in the user's area. Both the component costs and labor times and/or rates may also be based on paid insurance claim data, as opposed to suggested component costs and labor times set forth by the equipment manufacturer or some other source. Each of the component cost, labor time, and labor rate, may come from a single database, or from multiple databases. These databases may be owned by the owner of the system of the present invention. Alternatively, the databases may be owned by a separate entity and accessed by the system of the present invention.

As one exemplary option of the present invention, the system may ask the user whether the user is interested in effecting the repair using an aftermarket component. If the user answers in the negative, the estimate will be based upon original equipment manufacturer parts. If the user answers in the affirmative, however, the generated repair estimate may show a repair cost using an aftermarket, as well as or as opposed to, an OEM component. The estimate reflecting the use of the aftermarket component may appear on the same page as an estimate using an OEM component, or may appear on its own page. The estimate may also illustrate the cost savings realized if an aftermarket component is selected. When only certain components of a repair involving multiple components to be replaced are available in aftermarket form, the system may incorporate the cost of those aftermarket components into the estimate. Depending on the design of the system and the selections made by the user, the remainder of the components to be replaced can then be entered into the estimate using the cost of OEM components, remanufactured components, or used components. In such a case, the system may indicate those components that can, or cannot, be purchased in aftermarket form.

When an estimate using an aftermarket component is prepared, the system retrieves data relating to the component from an appropriate source. For example, the source may be a database(s) of aftermarket components that are available from one or more manufacturers, wholesalers, or retailers. The database(s) may be resident on the central data server, or on a data server(s) associated with a manufacturer or seller of aftermarket components. The system may also connect to another website in order to access information regarding an aftermarket component, retrieve information through the website, and provide it to the appropriate software application(s) of the system. For example, the system 5 may obtain the requisite information directly from the website of an aftermarket component manufacturer or seller.

With respect to the use of aftermarket components, it is contemplated that the information relating thereto may be retrieved from a database(s) owned or controlled by one or more equipment component wholesalers or retailers. The system may then select for use in the estimate the lowest cost found for the particular aftermarket component in question, may select the cost of the most conveniently available component, or may use some other criteria to determine which cost to select for use in the estimate. The system may further indicate the source of the aftermarket component(s) used in preparing the estimate. It may also be possible to allow the user to electronically purchase the aftermarket component(s), should the user so wish after being presented with the estimate(s).

As another exemplary option of the present invention, the system may ask the user whether the user is interested in effecting the repair using a remanufactured component. If the user answers in the negative, the estimate will be unaffected. If the user answers in the affirmative, however, the generated repair estimate may show a repair cost using a remanufactured, as well as or as opposed to, an OEM component. The estimate reflecting the use of the remanufactured component may appear on the same page as an estimate using an OEM component, or may appear on its own page. When an estimate using a remanufactured component is prepared, the system retrieves data relating to the component from an appropriate source. For example, the source may be a database(s) of remanufactured components that are available from one or more manufacturers, wholesalers, or retailers of such components. The database(s) may be the same or different than the database(s) accessed to obtain information on an aftermarket component(s). The database may be resident on the central data server, or on a data server associated with a seller or manufacturer of a remanufactured component. The system may also connect to another website in order to access information regarding a remanufactured component, retrieve information through the website, and provide it to the appropriate software application(s) of the system. The system may select for use in the estimate the lowest cost found for the particular remanufactured component in question, may select the cost of the most conveniently available component, or may use some other criteria to determine which cost to select for use in the estimate. The system may further indicate the source of the remanufactured component(s) used in preparing the estimate. It may also be possible to allow the user to electronically purchase the remanufactured component(s), should the user so wish after being presented with the estimate(s).

As yet another exemplary option of the present invention, the system may ask the user whether the user is interested in effecting the repair utilizing a used component. If the user answers in the negative, the repair estimate will be unaffected. If the user answers in the affirmative, however, the generated repair estimate may show a repair cost utilizing a used, as well as or as opposed to, an OEM component. In this case, the system may have access to one or more databases of used components. For example, the system may communicate with database(s) containing the inventory of one or more reclaim facilities, re-manufacturing enterprise, second hand retailers, online sales websites, online auction sites etc. In this embodiment, the system may be able to check inventory for availability of a particular component, retrieve cost information, and even reserve a component for purchase. The system may communicate with the used component vendor's database(s) directly. Alternatively, the system may simply link to an existing website associated with the used component vendor's database, through which inventory and price may be checked, and/or components can be purchased.

At some point during the gathering of information, the system may ask the user whether the user is interested in effecting the repair utilizing other than OEM components—which will generally be the default component type used by the system and method of the present invention. If the user answers in the negative, the repair estimate will be unaffected. If the user answers in the affirmative, however, the generated repair estimate may also show a repair cost using an aftermarket (i.e., new but non-OEM) component, a remanufactured component, and/or a used component. The estimate reflecting the use of the non-OEM component(s) may appear on the same page as an estimate using only OEM components, or may appear on a separate page(s).

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory content. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method of providing contextually aware variations to a work order by receiving an input from a user relating to a variation in an item within the work order and displaying to the user adjustments in other aspects of the work order in dependence of the variation made to an item.

2. The method according to claim 1, wherein the work order is a bill of materials or parts list.

3. The method according to claim 1, wherein the work order is a bill of materials or parts list together with an associated quantity of labour.

4. The method according to claim 1, wherein the adjustments in the other aspects of the work order are limited by at least a characteristic of an element defining the context of the work order.

5. Computer instructions stored within a non-volatile, non-transitory memory for execution by a microprocessor, wherein the computer instructions cause a process to be executed comprising providing contextually aware variations to a work order by receiving an input from a user relating to a variation in an item within the work order and displaying to the user adjustments in other aspects of the work order in dependence of the variation made to an item.

6. The computer instructions according to claim 5, wherein the work order is a bill of materials or parts list.

7. The computer instructions according to claim 5, wherein the work order is a bill of materials or parts list together with an associated quantity of labour.

8. The computer instructions according to claim 5, wherein the adjustments in the other aspects of the work order are limited by at least a characteristic of an element defining the context of the work order.

9. A method comprising:
receiving at a remote server first data from a user generated upon an electronic device, the first data relating to a context;
receiving at the remote server second data from a user generated upon the electronic device, the second data relating to a work order;
receiving at the remote server third data from a user generated upon the electronic device, the third data relating to a variation in an item of the work order;
generating options based upon the third data, the second data, and the first data; and
transmitting the options from the remote server to the electronic device for display to the user.

10. The method according to claim 9, wherein the work order is a bill of materials or parts list.

11. The method according to claim 9, wherein the work order is a bill of materials or parts list together with an associated quantity of labour.

12. The method according to claim 9, wherein the adjustments in the other aspects of the work order are limited by at least a characteristic of an element within the first data.

13. Computer instructions stored within a non-volatile, non-transitory memory for execution by a microprocessor, wherein the computer instructions cause a process to be executed comprising:
receiving at a remote server first data from a user generated upon an electronic device, the first data relating to a context;
receiving at the remote server second data from a user generated upon the electronic device, the second data relating to a work order;
receiving at the remote server third data from a user generated upon the electronic device, the third data relating to a variation in an item of the work order;
generating options based upon the third data, the second data, and the first data; and
transmitting the options from the remote server to the electronic device for display to the user.

14. The computer instructions according to claim 13, wherein the work order is a bill of materials or parts list.

15. The computer instructions according to claim 13, wherein the work order is a bill of materials or parts list together with an associated quantity of labour.

16. The computer instructions according to claim 13, wherein the adjustments in the other aspects of the work order are limited by at least a characteristic of an element within the first data.

17. A method comprising:
receiving from a user indications relating to a manufacturer and brand of the item sought;
receiving from the user an indication relating to a projected usage of the item over a predetermined period of time;
identifying items within a first database matching the user indications relating to the manufacturer and the brand of the item;
establishing a current usage for an identified item;
retrieving from a second database first data relating to projected cost of ownership for the identified based upon the current usage and the projected usage;
displaying the identified item to the user in conjunction with second data relating to the identified item retrieved from the first database and the first data.

18. The method according to claim 17, further comprising
filtering the identified items within the first database in dependence upon at least one of a range of current usage and a range of projected cost of ownership.

19. The method according to claim 17, wherein
the projected usage of the item is established in dependence upon the received indication which is a demographic based indication.
